(19) United States
(12) Patent Application Publication
(10) Pub. No.: US 2010/0287247 A1
(43) Pub. Date: Nov. 11, 2010

(54) METHOD AND SYSTEM FOR SECURE WEB SERVICE DATA TRANSFER

(75) Inventors: Gregory Allen Kohring, Heidelberg (DE); Luigi Lo Iacono, Heidelberg (DE)

Correspondence Address: SUGHRUE MION, PLLC, 2100 PENNSYLVANIA AVENUE, N.W., SUITE 800, WASHINGTON, DC, 20037, US

(73) Assignee: NEC EUROPE LTD., Heidelberg (DE)

(21) Appl. No.: 12/677,044

(22) PCT Filed: Sep. 7, 2007
(86) PCT No.: PCT/EP2007/007838

§ 371 Date: Jul. 27, 2010

(51) Int. Cl. G06F 21/00; G06F 15/16

(52) U.S. Cl. 709/206; 726/3

(57) ABSTRACT

Data transfer and staging services are common components in Grid-based or more generally in service-oriented applications. Security mechanisms are playing a central role in such services, especially when they are deployed in application fields like for instance e-health. The adoption of WS-Security and related standards to SOAP-based transfer services is, however, not straightforward. With MTOM, SOAP messages can be processed with WS-Security in a straightforward manner. The present invention provides an improved method for signing an MTOM-optimized SOAP message. A non-blocking signature generation approach is proposed enabling a stream-like processing with considerable performance enhancements.

### FIELD OF THE INVENTION

The present invention relates to a system and a method for Web Service data transfer, in particular, to a system and a method for Web Service data transfer with a binary data set over a network using standardised network protocols.

A Web Service is a software system designed and specified by W3C to support interoperable machine to machine interaction over a network. Web Services are frequently just Web Application Programming Interfaces (Web APIs) that can be accessed over a network, such as the Internet, and executed on a remote system hosting the requested services. Web Services based applications often require the secure transfer of large data sets or large data volumes, e.g. more than 1 MB, particularly more than 10 MB, more particularly more than 100 MB, between the service consumer and service provider. As part of the security requirements the application must provide the security services integrity and data origin authentication to the data transferred between these stakeholders. This is realised by applying a digital signature portion of WS-Security to the message. The WS-Security, i.e., Web Service Security, specification is deployed to extend Web Service capability and defines how to use encryption and signature in a Web Service based application to secure message exchanges, as an alternative or extension to conventional solutions such as HTTPS to secure the channel.

### BACKGROUND OF THE INVENTION

Many Grid-based applications or enterprise application integration require data transfer and staging services in order to deliver for instance input data to and output data from compute services. Depending on the concrete application field, security services play a vital role in such services and are often a critical distinguishing factor.

In medical treatment or research scenarios, in which medical images are transferred to simulation services, the confidentiality, integrity and authenticity of the image data as well as the obtained simulation results have to be ensured. An according end-to-end communication security component is a necessary building block for a secure data transfer service for such application fields.

Due to the fact that Grids and enterprise application integration are more and more converging to Web Service technologies and according standards, the application of WS-Security and related specifications seems to be a solution to provide such security mechanisms for data transfer services. The Web Service definition encompasses many different systems, but in common usage the term refers to clients and servers that communicate using XML messages that follow the SOAP standard. SOAP, originally stood for Simple Object Access Protocol, is a protocol for exchanging XML-based messages over computer networks, normally using HTTP/HTTPS. It forms the foundation layer of the Web Service stack, providing a basic messaging framework that more abstract layers can build on. It makes use of an Internet application layer protocol as a transport protocol. A closer look at the available technologies for data transfer using SOAP reveals, however, that it is not as straightforward as expected. FIG. 1 provides an overview of the available technologies and their relationship for transferring data, in particular binary data, with SOAP.

Since the SOAP protocol elements are XML-encoded, data transfer using SOAP falls back to embedding the data into XML documents. XML is usually presented as a way of describing text data within the context of a well-formed document containing meta-information (which is also text based) meant to bring some structure and form to the text data. There are, however, various domains that do not lend themselves nicely to being represented with textual data only. Thus, technologies for the inclusion of binary data into XML documents are needed and are obviously playing an important role in Web Service data transfer.

There are several approaches to circumvent the binary inclusion problem. A common approach is to encode the binary data into some string representation. The World Wide Web Consortium (W3C) published XML Schema Part 2 (data types second edition, W3C Recommendation, October 2004) to overcome the limitation in XML 1.0 second edition. In fact, the XML Schema defines the base64Binary type that can be used for this purpose. Three octets of binary data are mapped to four octets of base64-encoded data introducing a data expansion of 33% for UTF-8 text encoding (for UTF-16 text encoding the data expansion will double) as well as additional processing costs for coding and decoding.

SOAP with Attachments (SwA) is a W3C recommendation defining a way for binding attachments to a SOAP envelope using the multipart/related MIME type. The binary data is in an MIME attachment. It is referred to from the SOAP message with a cid: URI, which uses the value of the Content-ID MIME header to find the corresponding attachment. This combination of URI reference and raw data inclusion avoids the overhead and bloat of encoding, but introduces other limitations. Multipurpose Internet Mail Extensions (MIME) is an Internet standard that extends the format of email to support. MIME uses text strings to delineate boundaries between attachment parts. The entire message has to be scanned to find the string value used to delineate a boundary. Due to the avoidance of an explicit length field, however, the MIME specification places no actual limit on the size of attachments. MIME cannot be represented as an XML Infoset (an abstract Information Set which provides a consistent set of definitions for use in other specifications that need to refer to the information in an XML document) which effectively breaks the Web Services model causing e.g. that attachments cannot be secured using WS-Security straightforward.

A specific profile has been published and approved by the Organization for the Advancement of Structured Information Standards (OASIS) which specifies the usage of the OASIS Web Services Security, i.e., SOAP Message Security standard (WSS-Sec) with SwA. More specifically, it describes securing SOAP attachments using SOAP Message Security for attachment integrity, confidentiality and origin authentication, and receiving process of such a message. Furthermore, the standard allows the choice of securing MIME header information exposed to the SOAP layer, and also allows MIME transfer encodings to be changed to support MIME transfer, despite support for integrity protection and SwA messages to transit SOAP intermediaries. However, a choice of transport layer security (e.g. SSL/TLS), S/MIME, application using XML Signature and XML Encryption, and other SOAP attachment mechanisms (e.g. MTOM) is explicitly out of scope of this standard, and persisting signatures and signing portions of attachments are not considered neither. It furthermore needs to be considered, that before the security transformation can be performed, the attachment needs to be canonicalized according to its MIME type. Thus, various MIME type specific canonicalizations need to be supported, when applying this approach to secure SOAP attachments.

The Direct Internet Message Encapsulation (DIME) is a Microsoft-proposed internet standard for the transfer of binary and other encapsulated data over SOAP. The standard can be seen as an alternative to SwA and was supposed to be a simplified and more efficient version of MIME, in terms of decoding time. The initial draft was submitted to the Internet Engineering Task Force (IETF) in November 2001. The last update was submitted in June 2002. By December 2003, DIME had lost out, in competition with Message Transmission Optimization Mechanism (MTOM) and SwA, and Microsoft now describes it as “superseded by the SOAP Message Transmission Optimization Mechanism specification”. The DIME specification was created to address performance issues when processing MIME attachments. DIME is designed to be a fast and efficient protocol to parse, avoiding to have to scan the entire message to locate boundaries. The length of the attached files is encoded in the message header instead, enabling large attachments to be processed in chunks. The DATA field of an DIME record can contain up to 4 GB of data. Although this is a physical limitation on the amount of data in a single DIME record, there is no limit to the number of records in a DIME message. Since large attachments can be chunked, the DIME specification places no actual limit on the size of attachments. While DIME provided a more efficient processing model it still do not provide an XML Infoset model for the message and attachment. As for MIME, DIME breaks the Web Services model causing e.g. that attachments cannot be secured using WS-Security.

The W3C released a recommendation of a convention called XML-binary Optimized Packaging (XOP), i.e., a non-normative XML Schema, to provide a way to package XML documents for purposes of serialisation and transmission. XOP specifies a method for serialising XML Infosets with non-XML, base64-encoded content into MIME packages. In the serialisation step, a XML document is placed inside a XOP package (see FIG. 2). Any portions of the XML document that are base64-encoded are extracted and optimised. Each extracted and optimised chunk is replaced by an xop: Include element which refers to the corresponding new location in the XOP package. Thus, XOP enables to include binary data alongside with plain-text XML without influencing the XML Infoset, hence allowing to apply for example WS-Security to the whole message including all binary content. It furthermore promises to result in a much smaller dataset than the equivalent base64-encoded data without to worry about managing the binary data either on the encoding or the decoding side.

The SOAP Message Transmission Optimization Mechanism (MTOM) has been recommended by W3C and tries to leverage the advantages of above two techniques: the “by value” and “by reference” approaches. Actually, MTOM is a “by reference” method, since MTOM attachments are streamed as binary data within a MIME message part. Hence, MTOM messages are valid SwA messages, making it fairly easy to pass MTOM attachments to SwA or receive SwA attachments into an MTOM implementation lowering the cost of supporting MTOM for existing SwA implementations. Most notably is the use of the xop: Include element to reference the binary attachment of the message, which is defined in the XOP recommendation. With the use of this exclusive element the attached binary data logically becomes in-line (“by value”) with the SOAP message even though actually it is attached separately. Hence, MTOM provides a compromise between the MIME model and the Web Services model since an XML Infoset representation is available.

### SUMMARY OF THE INVENTION

The present invention was made in consideration with the above circumstances and has as an object thereof to provide a method and a system for secure Web Service data transfer over a network, in order to overcome the limitations of technology in prior art.

The object is achieved according to the invention by a lining with the features of independent claims of the present invention.

One of the embodiments in the present invention focuses on MTOM for data transfer with SOAP, since it allows the application of WS-Security for realising security services. In this specific embodiment the emphasis is drawn to the signature of SOAP messages and MTOM attachments respectively, because the approach in the prior art introduces delays at the sending side as will be illustrated in the following.

The method and system of the present invention facilitate to sign a SOAP message containing data sets, in particular binary data sets, more particular large binary datasets, and to send these messages using the MTOM standard. The large data sets means here data sets with a size more than 1 MB, particularly more than 10 MB, more particularly more than 50 MB, even more particularly more than 100 MB. Unlike conventional approaches, the present invention enables a non-blocking processing of the message, i.e., the transmission can begin without the necessity of waiting until the message signature has been completely calculated. This provides a significant improvement in performance compared with other approaches. Furthermore, unlike some conventional implementations which attempt to reconstruct the message's original XML Infoset in memory before sending and are therefore limited in the size of messages they can send, the present invention has no such limitations.

One idea of the present invention is to include a reference into the Signature element of the WS-Security Header which refers to the actual signature value contained and send as the last attachment in the multipart MIME format used to convey the message. To achieve standard conformance with WS-Security and MTOM one of the embodiments encrypts the Signature element so that it can be optimized according to the procedures specified by MTOM.

Note, that this approach is not limited to a single signature process for a given message, but allows/supports to sign multiple distinct parts of the message independently from each other resulting in multiple distinct signatures.

According to this idea, the root part of the MIME message may contain, e.g., the SOAP envelope in which the XML Signature element header has been encrypted and optimized according to, e.g., the MTOM standard. The signature digest corresponding to the different MIME parts may calculated while the message is being transferred over a network in a streamed fashion. After all the data has been sent, the complete XML Signature element is generated, encrypted and may be sent in the last MIME segment.

In order to achieve these goals, the present invention provides a method for Web Service data transfer with a binary data set over a network comprising the steps of: encoding the binary data set outside of a transfer protocol envelope to temporarily construct an information set of the message; passing at least a part of the message to a security processing layer; and calculating a signature of the message while the message is being transferred over the network; extracting the contents of the signature by using a binary packaging method and inputting information based on said signature into the information set of the message; selectively encoding the contents of the signature and sending it as the last part of a multi-part message.

In a preferred embodiment, subject of the present invention is a method, wherein the encoding of the binary data sets is base64. A person skilled in the art will understand that further encoding method such as uuencode, base32, base85 may also applied.

The transfer protocol applied in the present invention may be SOAP.

According to a preferred embodiment, the transfer of the message does not break the WS-Security requirement, i.e., the data sets can be secured using WS-Security, which can be of course also defined by another institute with different names and similar requirements.

A preferred embodiment of the present invention, focuses on a message based on XML standard. XML is an general-purpose markup language and is at the moment very popular, but there are several standards for marked up languages for describing of defining of art of electronic documents also used for constructing a message, such as HTML, XHTML, in particular, the standard generalised markup language (SGML), which XML is simplified from.

In a preferred embodiment, the subject of the invention describes the extracting of signature by using a standardised mechanism, i.e., XOP, a binary optimised packaging. A XOP package is created by placing a serialization of the XML Information set, i.e., XML Infoset, inside of an extensible packaging format. Selected portions of its content that are encoded binary data, e.g. base64-encoded binary data, are extracted and re-encoded (i.e., the data is decoded from base64) and placed into the package. The locations of those selected portions are marked in the XML with a special element that links to the packaged data using URIs. A skilled person in the art will understand that further packing methods may also applied.

In a preferred embodiment, the subject of the invention refers to a standardised SOAP message transmission optimising mechanism (MTOM), which is recommended by W3C. This mechanism describes an abstract feature for optimising a transmission and/or wire format of a SOAP message by selectively encoding portions of the message, while still presenting an XML Infoset to the SOAP application.

A preferred embodiment describes sending the contents of the signature as a multi-part MIME message, which is standardised format for sending messages. However for special application between server and client, a proprietary format may be used as well.

The present invention also relates to a system which is adapted to perform the above-mentioned method steps.

### BRIEF DESCRIPTION OF THE DRAWINGS

The invention will be described more in detail with respect to the following Figures:

FIG. 1 is a block diagram of SOAP data transfer protocol stack.

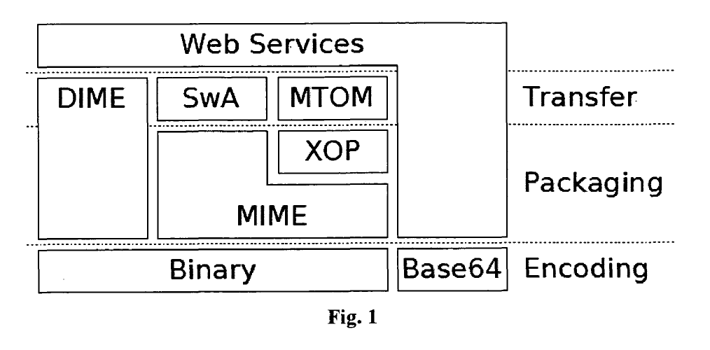

FIG. 2 is a flow diagram of XOP processing Model.

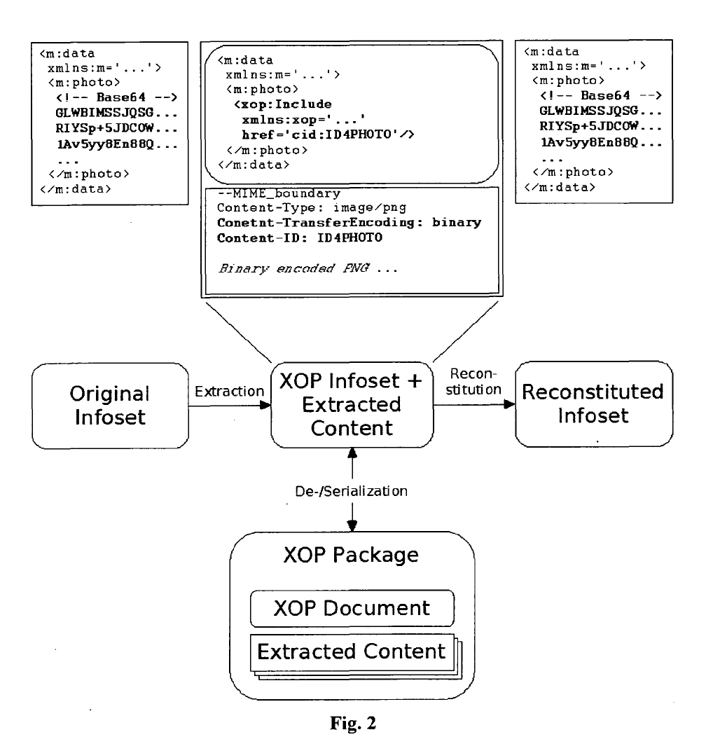

FIG. 3 is a flow diagram of signature generation of an MTOM-optimized SOAP Message.

FIG. 4 is a flow diagram of non-blocking signature construction of an MTOM-optimized SOAP Message according to the present invention.

FIG. 5 is a diagram of the network throughputs measurement of two Java based frameworks.

### EMBODIMENT OF THE INVENTION

The WS-Security standard specifies that only data within the SOAP enveloped should be processed with the defined security mechanisms. Thus, WS-Security cannot be applied to SwA or DIME messages, but can be applied to MTOM-optimized SOAP messages.

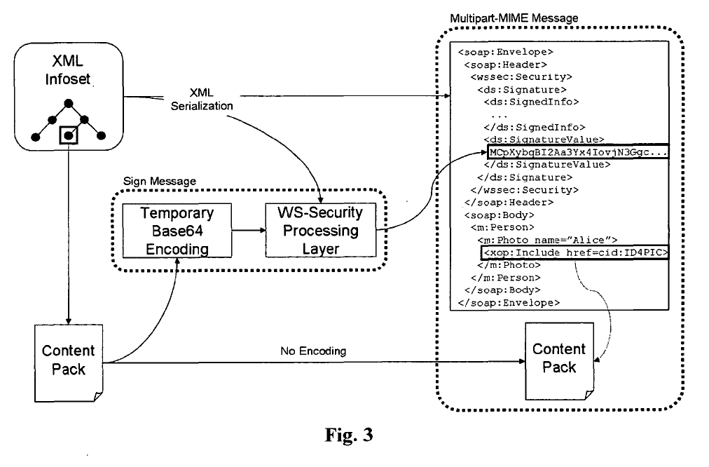

With MTOM, everything is inside the SOAP envelope, at least logically. The physical treatment within the endpoints and on the wire is different. Here large (binary) data are handled outside the SOAP envelope to reduce the memory usage and the required amount of data for transmission. Whenever the SOAP message or parts of it containing logically included data have to be processed, the externally managed data becomes temporary part of the message in order to perform the processing. This can be illustrated conveniently by referring to the process of signature generation (see FIG. 3).

Before handing the message or parts of it to the WS-Security processing layer, the externally managed content may be included. This requires a base64 encoding step, to temporarily construct the XML Infoset. On this volatile XML document the mechanisms defined in WS-Security can be applied and in the context of the present invention, in particular, the XML-Signature processing layer. The outputs of the signature generation process—the digest and signature value—can then be placed into the WS-Security Header. Hereafter, the temporarily created message is discard and the content is still managed external to the message in binary format.

The standard approach to signing a SOAP message when MTOM is used, is to re-create the original XML Infoset, either logically, or in-memory before signing the message. As the SOAP Envelope is normally in the first part of multi-part MIME message, the signature must be completed in order to construct the WS-Security Header, which for large files this can be a considerable bottleneck, i.e., the message transferring according prior art is a blocking approach.

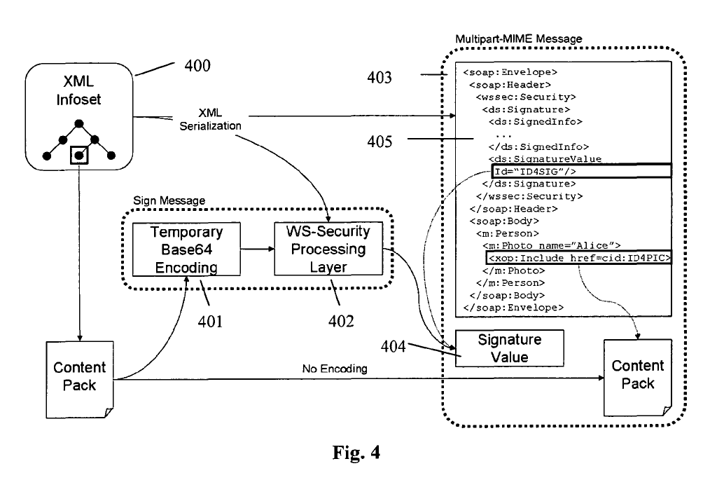

The present invention provides a non-blocking approach which optimises the signature process. According to the present invention, the signature is calculated while the message is being sent, i.e., the present invention provides streaming while at the same time compliant with the current WS-Security specifications and compatible with the standard SOAP processing model. The approach of the present invention preferred uses XOP to extract the contents of the ds:Signature, then apply MTOM to send this content as the last part of a multi-part MIME message. The digest values of the initial parts of the MIME message can be calculated while the data is being streamed over the network, leaving the actual construction of the signature until the system is ready to send the last part of the MIME message (see FIG. 4).

According to the standard XOP is only applied to content of type xs:Base64Binary. Hence, according to the preferred embodiment, it is also possible to fulfil the standard, in that the ds:Signature element may encrypted first, then apply XOP to the xenc:CipherValue element. According to the present invention, signing may followed by encrypting.

In the following a specific implementation of the present invention will be described in detail, in particular it will be described how the method of the present invention can be made to fit within a standard Web Service (WS) framework, e.g., a JAX-WS framework. JAX-WS stands for Java application programming interface for XML Web Services and uses annotation such as other Java application programming interface, in order to facilitate the development and deployment of Web Services.

Although few WS frameworks are fully compliant to the JAX-WS standard, most Java-based frameworks like Axis do adhere to the JAX-WS processing model.

According the JAX-WS standard, the Handler framework for implementing the WS-Security functionality and the Java Activation Framework (JAF) along with JavaMail for implementing the MTOM functionality may be used. Within JAF, the data is put on the wire through the writeTo (OutputStream outputStream) method of the javax.activation.-DataHandler. In particular, there will be one instance of this class for each xop:Include element, with each instance writing to a separate part of the multi-part MIME message. Hence, in order to realise the goal of calculating the digest value while the MTOM data is being sent, this class must he extended and the writeTo (OutputStream outputStream) method overridden to include calculation of the digest while the data is being streamed out. At this point the data may encrypted by using key material passed in from a suitable WS-Security Handler.

Unlike standard implementations where the signature is computed and inserted into the SOAP header within a suitable Handler class, the WS-Security Handler class developed here is only responsible for collecting the security material and passing it to the data handlers as well as inserting the XOP optimized ds:Signature element into the security header. The actual work of preparing the signature is delegated to a second class extending javax.activation.DataHandler which is responsible for generating the content of the ds:Signature element and inserting it (or its encrypted counterpart) as the last part of the multi-part MIME message.

### EXAMPLE

An exemplary implementation of the method or system according to the present invention discussed in the previous section is described here. Two popular Java based WS frameworks are investigated. The first; Axis2 from Apache has a WS-Security framework in which the MTOM optimized parts are signed using the approach of reconstructing the original XML infoset. The second, XFire from Codehouse, does not sign the MTOM attachments, instead only the elements appearing in the envelope are available for signing. As XFire does not have a complete WS-Security framework, the non-blocking approach was implemented in it and compared with the standard approach from Apache Axis2.

The experimental setup consisted of an XFire or Axis client on a first computer and an Apache Tomcat Server hosting the corresponding service on a second computer connected by a 100 Mbps network. The client machined contained, e.g., an Intel Pentium 4, 3.2 GHz cpu, while the server machine contained, e.g., a dual AMD Opteron 2.6 GHz cpu.

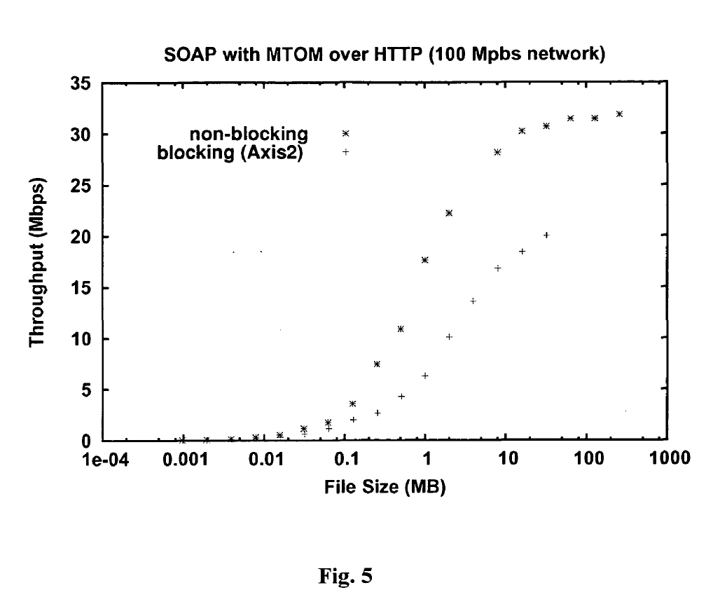

As a first step, the performance of both frameworks in the absence of any security overhead was measured in order to set the scale for the absolute performance. The results depicted in FIG. 5 show how both frameworks, in the absence of security, are capable of transferring large files with a reasonable efficiency, i.e., the throughput is 70% of the peak bandwidth. The similarity between the results is to be expected as both frameworks are using the same components at the transport level, namely, the Jakarta Commons Http Client on the client side and the Apache Tomcat Http Server on the server side. Hence, the upper curves in FIG. 5 simply demonstrate the efficiency by which large files can be transferred using SOAP/HTTP. The lower curves show the performance when signing large messages using the blocking and non-blocking approaches. For the non-blocking approach, the signature, along with the rest of the message, was encrypted in order to be strictly compliant to the MTOM standard. As can be seen the non-blocking approach is 50% faster than the blocking approach, although both approaches are significantly slower than without signature. For the Axis2 framework there is an additional problem in that the JVM crashes with an out-of-memory error when signing large files. Presumably this indicates that Axis2 is trying to completely recreate the original XML Infoset in memory before signing.

Data services are a basic functionality in service-oriented environments such as Grids. Depending on the concrete application field, integrated security mechanisms are a vital prerequisite. Through the lack of appropriate standards, the application of WS-Security and related specifications has not been easily possible. Starting with MTOM, SOAP messages can be processed with WS-Security. However, when transferring large data sets such as given by medical images, the application of the standard approach for signature generation based on WS-Security to MTOM-optimized SOAP messages introduces a considerable bottleneck. The non-blocking signature generation method of the present invention reduces the total transmission time significantly which results in an increased throughput of 50% in comparison to the standard blocking approach.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from scope of the present invention. In particular, although features and elements of the present invention are described in the preferred embodiments in particular combinations, each feature or element can be used alone without the other features and elements of the preferred embodiments or in various combinations with or without other features and elements of the invention. Therefore, the scope of the present invention should not be limited to the methods and systems described herein, but only by the language of the claims and the equivalents of those methods and systems.

1. Method for secure Web Service data transfer with a binary data set over a network comprising the following steps: encoding the binary data set outside of a transfer protocol envelope to temporarily construct (401) an information set of a message; passing at least a part of the message to a security processing layer (402); and calculating a signature (404) of the message while the message is being transferred over the network; extracting the contents of the signature by using a binary packaging method and inputting information based on said signature into the information set of the message (405); selectively encoding the contents of the signature and sending it as the last part of a multi-part message (403).

2. Method according to claim 1, wherein the encoding of the binary data sets is base64.

3. Method according to claim 1, wherein the transfer protocol is SOAP.

4. Method according to claim 1, wherein the transfer of the message is WS-security compliant.

5. Method according to claim 1, wherein the message is XML-based.

6. Method according to claim 1, wherein the binary packaging method is according to the XOP standard.

7. Method according to claim 1, wherein the selectively encoding is performed according to the MTOM standard recommended by W3C.

8. Method according to claim 1, wherein the selectively encoding is performed according to the Web Service Security SOAP Message with Attachments (SwA) Profile specified by OASIS.

9. Method according to claim 1, wherein the multi-part message is a multipart MIME message.

10. Method according to claim 1, wherein the size of binary data set is larger than 1 MB, preferably larger than 10 MB, more preferably larger than 50 MB, even more preferably larger than 100 MB.

11. System for a secure Web Service data transfer with a binary data set over a network, said system comprising: means for encoding the data set outside of a transfer protocol envelope to temporarily construct an information set of a message; means for passing at least a part of the message to a security processing layer; and means for calculating a signature of the message while the message is being transferred over the network; means for extracting the contents of the signature by using binary packaging and for inputting information based on said signature into the information set of message; means for selectively encoding the contents of the signature and sending it as the last part of a multi-part message.
